(19) United States
(12) Patent Application Publication
(10) Pub. No.: US 2013/0054654 A1
(43) Pub. Date: Feb. 28, 2013

(54) GEOGRAPHIC INFORMATION SYSTEM FOR COLLECTING DATA AND TRACKING AGRICULTURAL AND FOOD-RELATED PROPERTIES BY TYPE AND USE

(71) Applicants: Brian Thomas Sterling, Guelph (CA); Nicolas Robert Albu, Guelph (CA)

(72) Inventors: Brian Thomas Sterling, Guelph (CA); Nicolas Robert Albu, Guelph (CA)

(73) Assignee: On-Trace Agri-Food Traceability (Ontario)

(21) Appl. No.: 13/290,881

(22) Filed: Nov. 7, 2011

Related U.S. Application Data
(60) Provisional application No. 61/527,976, filed on Aug. 26, 2011.

(51) Int. Cl. G06F 7/00

(52) U.S. Cl. 707/803; 707/E17.018; 707/E17.032

(57) ABSTRACT

There is disclosed a computer-implemented GIS and method for collecting data and identifying, registering and tracking agricultural and food-related properties by type and use. Agricultural and food-related properties are identified by cross-referencing the real estate database with various agricultural group databases maintained by one or more agricultural producer groups or organizations. The real estate database and the various agricultural group databases are merged to produce a GIS of agricultural and food-related properties identified by type and use, with accurate location and boundaries and all relevant ownership and contact information.

### CROSS-REFERENCE TO RELATED APPLICATIONS

This application claims priority from U.S. Provisional Application No. 61/527,976, entitled GEOGRAPHIC INFORMATION SYSTEM FOR COLLECTING DATA AND TRACKING AGRICULTURAL AND FOOD-RELATED PROPERTIES BY TYPE AND USE, and filed on Aug. 26, 2011, which is hereby incorporated by reference in its entirety.

### FIELD

The present disclosure relates to a geographic information system and method for collecting data and identifying, registering and tracking agricultural and food related properties by type and use.

### BACKGROUND

In the prior art, geographic information systems (GIS) have been developed and designed for various types of applications and functions in the agricultural industry. For example, US20020022929 issued to Ell discloses a system and method for creating field attribute maps for site-specific farming. Ell discloses that field attribute maps containing agricultural data may be collected from a field and converted into a useful format used to create application maps, in which the location of the fields may be identified by their geographic coordinates. As another example, US 20090082997 issued to Tokman et al. discloses a method of identifying and evaluating the relationship between epidemic clusters in a GIS, in order to help contain an epidemic. As yet another example, an academic paper by Norstrom, 2001 entitled “Geographic Information System (GIS) as a Tool in Surveillance and Monitoring of Animal Diseases” points to the advantage of mapping the locations of farms and other facilities with animals, as it could make the management of an epidemic easier, and also provide a tool to evaluate different strategies to prevent the spread of infectious diseases. However, the Norstrom paper also points to the scarcity of data available for performing such analysis. Still another example is U.S. Pat. No. 7,681,527 issued to Pratt which discloses a method and system for tracking and managing animals and/or food products. However, Pratt fails to disclose how data could be collected for such a GIS. Thus, while the need for a robust GIS for various agricultural applications and functions has been recognized, the lack of a means to efficiently collect geographic data has significantly hindered the development of GIS applications.

What is needed is an improved system and method for collecting GIS data and tracking agricultural and food-related properties which overcomes at least some of the limitations identified above.

### SUMMARY

The present disclosure relates to a computer-implemented GIS and method for collecting data and identifying, registering and tracking agricultural and food-related properties by type and use. In an embodiment, the system and method is adapted to generate a map on an electronic display of agricultural and food-related properties within a defined geographic region identified by their type and use.

In an embodiment, data received from a land registry or real estate database includes information on the location and boundaries of all real estate properties within a given jurisdiction such as a municipality, county, region, state, province or country. Agricultural and food-related properties are identified by cross-referencing the real estate database with information from various agricultural group databases maintained by one or more agricultural producer groups or organizations, such as pork producers, dairy producers, poultry producers, beef producers, etc. The land registry or real estate database and the various agricultural group databases are merged to produce a GIS of agricultural and food-related properties identified by type and use, with accurate location and boundaries and all relevant ownership and contact information.

In another embodiment, mobile devices are used by field staff to supplement agricultural property registration data by updating address, contact information, land use, environmental and other related data for a given agricultural or food-related property while field staff are on site at the property.

In another embodiment, all agricultural and food-related properties of a certain type or use within a given jurisdiction can be readily identified by highlighting the properties on a map generated on an electronic display.

In another embodiment, the ownership and contact information for each identified agricultural or food-related property can be readily accessed by selecting the agricultural or food-related property via a graphical user interface (GUI) in order to quickly locate the ownership and contact information for each of the identified real estate properties.

In another embodiment, the ownership and contact information and an accurate geographic location for every identified agricultural or food-related property in a given jurisdiction may be made available to and accessed by first responders (e.g. public health authorities) via wireless communications to assist the first responders with quickly locating at risk agricultural and food-related properties for the purposes of visiting the properties contacting the owners of the properties, or other first responder activities.

In another embodiment, agricultural and food-related properties of different types and uses may be co-displayed on a map of a given jurisdiction generated on an electronic display based on proximity to another agricultural or food-related property, or based on location within a geographic region, or based on shared property boundaries as identified in the land registry or real estate database, such that all at risk agricultural and food-related properties in the context of an epidemic or other public health emergency can be quickly identified and secured by contacting the owners of the identified agricultural and food-related properties.

In yet another embodiment, each agricultural or food-related property identified in the GIS may be uniquely, identified by address, GPS coordinates, or by another unique property identifier for the purposes of tracking the movement of agricultural produce or livestock from an originating property to a destination property, and all via point properties in between. Such properties may include farms, stockyards, processing plants, wholesale warehouses, exhibition grounds, and retailers, for example. In addition, the agricultural produce or livestock may be identified based on the originating property, with tracking through the intermediate via points to the destination property, such that movement of agricultural produce or livestock can be readily tracked back to the originating property from any destination property or from any via point in between.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways and with other supplemental data. Also, it is to be understood that the phraseology and terminology employed herein are for the purpose of description and should not be regarded as limiting.

### BRIEF DESCRIPTION OF THE DRAWINGS

FIG. 1 shows a schematic block diagram of a GIS in accordance with an embodiment;

FIG. 2 shows a schematic block diagram of a mobile network architecture for collecting field data for the GIS of FIG. 1 in accordance with an embodiment;

FIG. 3 shows an illustrative graphical user interface for interacting with the system of FIG. 1;

FIG. 4 shows a schematic flow chart of a method in accordance with an embodiment; and

FIG. 5 shows a generic computer device and network for providing a suitable operating environment for various embodiment of the invention.

### DETAILED DESCRIPTION

The present disclosure relates to a computer-implemented geographic information system (GIS) and method for identifying, registering and tracking agricultural and food-related properties by type and use. As noted above, prior art systems have recognized the need for robust systems developed and designed for various applications and functions in the agricultural industry. However, heretofore, the options available for collecting and tracking the necessary data have been limited due to a lack of an efficient means for collection.

With the relatively recent development of electronic land registration systems, the inventors have realized that by utilizing such databases developed for real properties, the process of collecting and tracking type and use data for potentially many thousands of agricultural and food-related properties in a given jurisdiction or geographic region can be greatly simplified. More generally, the inventors have developed a system and method for easily and cost-effectively identifying, registering and tracking agricultural and food-related properties in a given jurisdiction by type and use by utilizing real estate location and boundary information from a land registry or real estate database.

As will be explained in further detail below, data received from a land registry or real estate database includes information on the location and boundaries of all real estate properties within a given jurisdiction, such as a municipality, district, county, region, state, province or country. Preferably, the real estate database is a database already developed for real estate land title registration and conveyancing purposes, such that the location and boundary of each real estate property data is accurate. For example, in the Province of Ontario, Canada, land registry or real estate data extracted from the Province of Ontario Land Registry Information System (POLARIS), maintained by Teranet Inc., may be used in the real estate database. POLARIS consists of a title database containing abstracts of title information; and a database of maps that presently specifies millions of land parcels in the province. Similar electronic land registry systems being considered, currently being developed, or already available in other jurisdictions could also be used.

In an embodiment, agricultural and food-related properties are identified by cross-referencing a real estate database (such as POLARIS in the Province of Ontario, Canada), with agricultural group databases maintained by one or more agricultural producer groups or organizations, such as corn producers (e.g. Ontario Corn Producers' Association), wheat producers (e.g. Grain Farmers of Ontario), dairy producers (e.g. Dairy Farmers of Ontario), pork producers (e.g. Ontario Pork Producers' Marketing Board), poultry producers (e.g. Chicken Farmers of Ontario), beef producers (e.g. Ontario Cattlemen's Association), etc. These different types of agricultural producers and groups are often organized independently, and may not share information about their respective members outside of their group.

In order to overcome these limitations, the present system and method collects data from all of these different agricultural groups and cross-references the collected data against a real estate database containing location and boundary information on all parcels of real estate within the jurisdiction. Thus, the real estate database and databases maintained by the various agricultural groups may be merged together to create a GIS of all agricultural and food-related properties within the jurisdiction, with each agricultural or food-related property identified by type and use, geographic location and boundaries, and all relevant ownership and contact information. Based on this merged database, all agricultural and food-related properties of a certain type or use within a given jurisdiction (e.g: the Province of Ontario, or any Country, Region, District or Municipality, or a portion thereof) can be readily identified and highlighted on a map of a given jurisdiction, as generated on an electronic display.

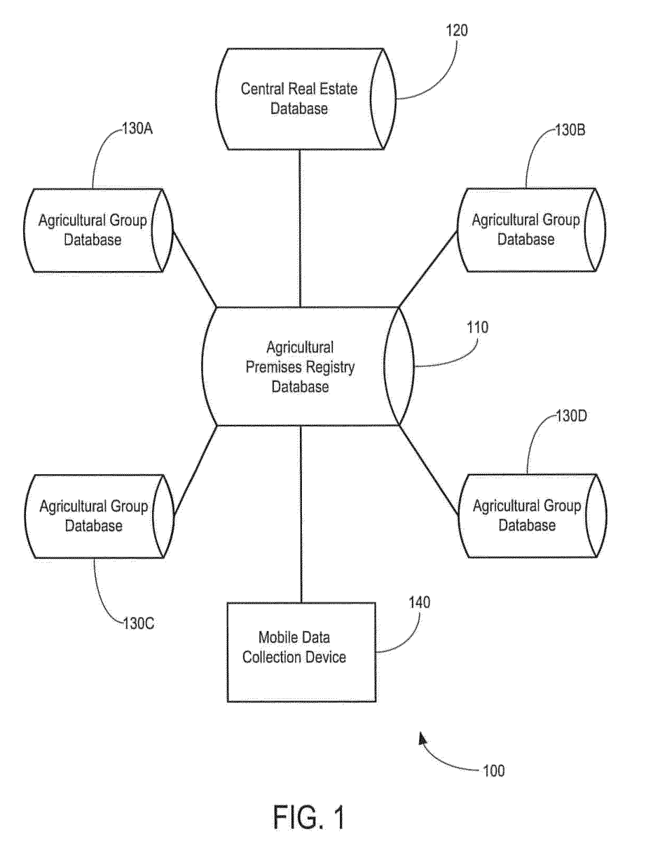

The system and method in accordance with an illustrative embodiment will now be described in further detail with reference to FIGS. 1 to 5.

Now referring to FIG. 1, shown is a schematic block diagram of a GIS 100 in accordance with an embodiment. As shown, GIS 100 includes an agricultural premises registry database 110 for tracking agricultural and food-related properties together with type and use information. The agricultural premises registry database 110 may be operatively connected or connectable to a real estate database 120 for updating the registry database 110 from time to time to note any changes in ownership or use. For example, a parcel of land may be subdivided into smaller parcels with a different use, such as a farm property that is sold for development which is then subdivided into lots for residential homes. In such a case, the change in ownership and use of the land may be updated to the agricultural premises registry database 110 such that the property is no longer tracked as an agricultural property.

Still referring to FIG. 1, GIS 100 may be operatively connected or connectable to various agricultural group databases 130A-130D for the purposes of identifying the type and use of the agricultural and food-related properties identified in the agricultural premises registry database 110. The various agricultural group databases 130A-130D may be used for updating the registry database 110 from time to time to note any changes in the type of agricultural activity taking place at the agricultural and food-related properties listed in agricultural premises registry database 110.

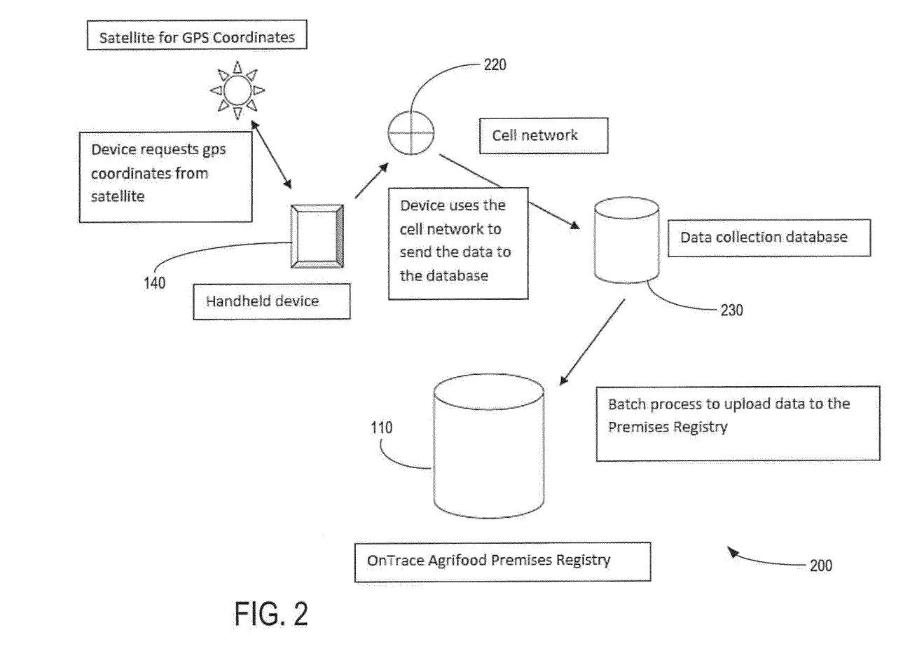

Still referring to FIG. 1, GIS system 100 may be operatively connected or connectable to a mobile data collection device 140 which may be used by field personnel to gather or display agricultural property or usage data directly from the field (e.g. while visiting a premises). Mobile data collection device 140 will be described in more detail below with reference to FIG. 2.

As shown in FIG. 2, mobile data collection device 140 may be a handheld device such as a smart phone, PDA, tablet, or the like. Mobile data collection device 140 may include a GPS module for requesting GPS coordinates from satellites to determine the current geographic location of the device 140. The GPS latitude and longitude coordinates obtained from the satellites may be recorded as part of the data collection record or form being completed.

In an embodiment, mobile data collection device 140 includes a keyboard, voice activated entry, or touch-screen interface for inputting and viewing various data for an agricultural property into an electronic form. Any data input into the form may be associated with the GPS latitude and longitude coordinates recorded for the current location. Mobile data collection device 140 may request responses to a series of data collection questions for a form that is customizable for different types of commodities or agricultural products. The data collection questions in the form may include, for example, contact information such as name, address, phone of the main contact information for the agricultural premises. The data collection questions in the form may further include questions about what is being farmed on the premises—such as cattle, chicken, swine, corn, wheat or any number of other commodities.

Once responses to the data collection questions have been obtained and a form is completed, mobile data collection device 140 sends the data via a wireless network, such as a cellular network 220, to a data collection database server 230. If a cellular network 220 is not available at a given location, the data may be temporarily stored in the mobile data collection device 140 until the device 140 is in range of a cellular network 220 or other data downloading device or network. At that point, the data is sent. Other wireless networks, or combined wired and wireless networks, may be used to achieve the same results.

In an embodiment, data collected at the data collection database server 230 may be accessed by the agricultural premises registry database 110, where the data is analyzed and cross referenced to the current database of agricultural and food-related properties. If a premises is verified, a unique premises identifier (PID) may be issued to the agricultural premises to which the collected data relates, and the collected data may be stored in the agricultural premises registry database 110 together with the granted PID.

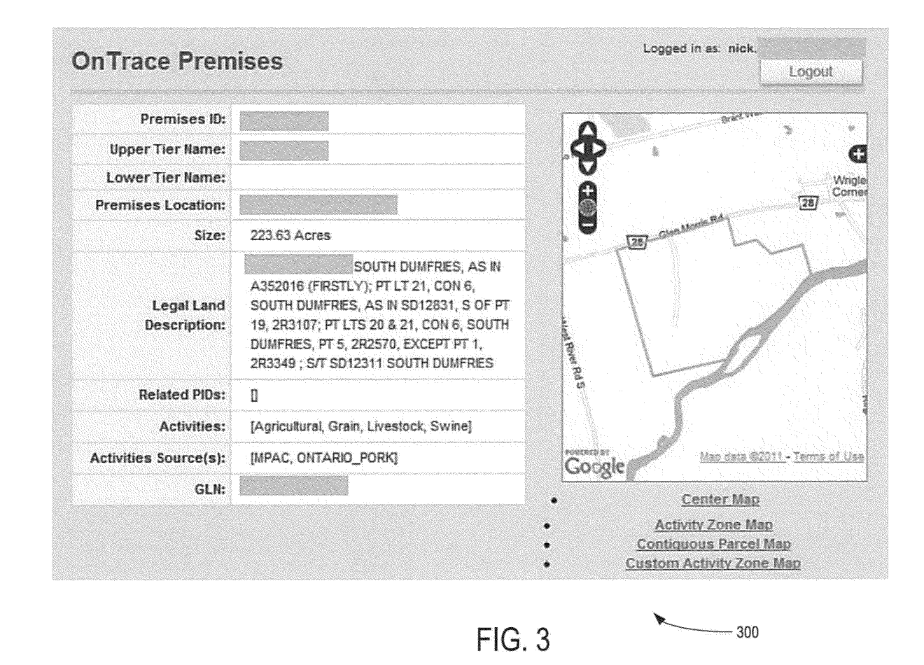

As mentioned above, the data collected in the agricultural premises registry database 110 may be displayed on an electronic display in a graphical user interface or GUI format for the purposes of providing information about a given agricultural property. An illustrative example is provided in FIG. 3, where the GUI display includes a map and an outline of the boundaries of an identified agricultural or food-related property.

In an embodiment, the map generated on the electronic display may be enlarged to provide a more detailed view of the identified agricultural or food-related property, or reduced to provide a view of the identified agricultural or food-related property in the context of the surrounding area.

In this illustrative embodiment, details about the property may include a PID used to uniquely identify the property. An upper tier name may identify the district, county or region in which the property is located. An optional lower tier name may also be provided. The database record for this agricultural or food-related property may also include a street address, and an indication of the size of the property (e.g. measured in acres). In an embodiment, a legal description of the land and other data may also be included to accurately identify the boundaries of the property, as obtained from the real estate database 120 described earlier with reference to FIG. 1.

In an embodiment, the information for the agricultural property may further include related PID's and a list of agricultural activities or uses at the property. If there are multiple agricultural activities taking place on the property, all activities or uses may be named and categorized using standard identification codes. An optional field may indicate the particular agricultural group database(s) 130A-130D from which the activities or uses has been derived. Finally, the information for the agricultural property may also include a Global Location Number (GLN).

The GLN is part of the GS1 systems of standards and may be used to uniquely identify a location using a structured 13 digit number. A GS1 Identification Key is used to identify physical locations or legal entities. The GS1 Identification Key comprises a GS1 Company Prefix, Location Reference, and Check Digit. Locations identified with a GLN may be a physical location such as an agricultural or food-related property, or a legal entity such as a company. A GLN may be used in electronic messaging to identify a specific location.

In the present system and method, a GLN associated with an agricultural or food-related property may be used to uniquely identify the property using a global standard. Therefore, the present system is capable of integrating with or collaborating with other systems based on a global standard.

Still referring to FIG. 3, alternative views of the property may be accessed, including for example an activity zone map, a contiguous parcel map, and a custom activity zone map. These views may be used, for example, to show the agricultural and food activities taking place on proximate premises, or to group locations that have like usage into one geographic display, or to visually display and link premises that are under the control of a particular owner or operator.

Thus, based on the information collected from the real estate database 120, various agricultural group databases 130A-130D, and via a plurality of mobile data collection devices 140 used by field staff, a comprehensive agricultural premises registry database 110 may be built and maintained. Once collection of information for agricultural and food-related properties in a given jurisdiction is substantially complete, the premises registry database 110 can provide readily available information on virtually any agricultural or food-related property, including accurate geographic location and boundaries, ownership and contact information, type of agricultural activities or use of the property, and related information.

In an embodiment, information about various agricultural and food-related properties may be quickly accessed by selecting a particular real estate property displayed on a map by clicking on the property with a pointer (e.g. mouse or pad) or via a pressure sensitive touch-screen interface. The system and method may be further adapted to generate a map on an electronic display of various types of agricultural and food-related meeting particular search criteria. Thus, for example, a search for agricultural and food-related properties showing only beef cattle farming may be identified in a given geographic region. Alternatively, a search may include agricultural and food-related properties that are multi-use and include two or more types of specified agricultural activities. In order to better illustrate the present system and method, an exemplary use case will now be described.

While updating the database through periodic updates from various database sources (e.g. see FIG. 1) and mobile data collection from the field (e.g. see FIG. 2) is expected to be an on-going continuous activity, once the agricultural premises registry database 110 is substantially complete, it may be used to provide critical information for a number of agricultural uses.

As an illustrative example of a case, the system and method may be adapted to rapidly identify and map together all disparate types of agricultural farms and food processing locations that may be susceptible to a particular infection or disease. For example, for a given geographic area, all agricultural and food-related properties with activities including farming cloven-hoofed animals may be identified for potential exposure to hoof-and-mouth disease. This may include identifying all agricultural and food-related properties identified in the agricultural premises registry database 110 with activities including cattle farming, sheep farming, pig farming and goat farming. Previously, this would have required contacting each agricultural group to identify members in a given geographic area, and attempting to contact each one individually from a number of different lists. As well, given the separate lists, two adjoining agricultural property owners may have no idea that the livestock on one agricultural property may be susceptible to livestock on another agricultural property if they are different types of cloven-hoofed animals.

Advantageously, with the present system and method, all agricultural and food-related properties susceptible to a particular type of infectious disease may be identified by determining the types of livestock that may be exposed. The output to the user may be a visual display of the geographic location and boundaries of all identified real estate properties that are displayed together to present a complete map of all potentially affected agricultural and food-related properties. The map may be zoomed in to obtain more detailed information about the location and boundaries of the properties. Also, more information about a particular property may be obtained by focusing on the property with a pointer and getting more detailed information including full contact information for the owner or operator. The ability to identify shared property boundaries and quickly locate other nearby susceptible properties may allow first responders to take rapid action in order to minimize and contain the risk of an outbreak. A rapid response to an emerging outbreak may assist in containing a potential epidemic by quarantining all affected properties and adjoining or nearby at risk properties at the earliest possible stage.

As another illustrative use case, the PID as described above may be used to uniquely identify the source of commodities or agricultural goods or livestock for the purposes of tracking them from a destination property to a source property, or from any via point in between. The system may be used to track the commodities or agricultural goods from the originating property using the PID, through each intermediate point or property via their unique PIDs, and finally to the destination property by its unique PID. Any number of tracking technologies may be used to associate an identified commodity or agricultural good or livestock, for example radio frequency identification (RFID) tagging, bar coding, or any number of unique marking systems readable using radio frequency, magnetic, or optical technologies. Based on recorded unique PIDs to track the delivery of commodities and goods from the originating property to a destination property, such commodities and goods may be quickly traced back to the originating property in case there is any problem with the commodities or goods identified after they have left the originating property.

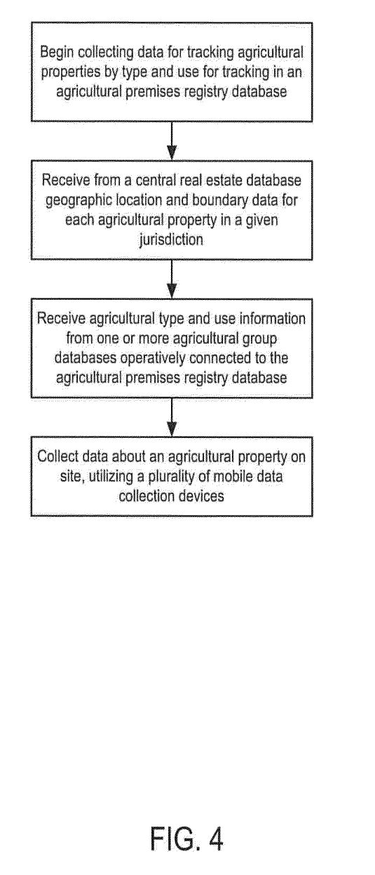

Now referring to FIG. 4, shown is a schematic flow chart of a method 400 in accordance with an embodiment. As shown, at block 410, method 400 begins collecting data for tracking agricultural and food-related properties by type and use for tracking in an agricultural premises registry database.

Method 400 proceeds to block 420, where method 400 receives from a real estate database geographic location and boundary data for each agricultural property in a given jurisdiction.

Method 400 then proceeds to block 430, where method 400 receives agricultural type and use information from one or more agricultural group databases operatively connected or connectable to the agricultural premises registry database.

Method 400 then proceeds to block 440, where method 400 collects data about an agricultural property on site, utilizing a plurality of mobile data collection devices. As explained earlier, the mobile data collection devices may be adapted to obtain global positioning system (GPS) location coordinates to validate the location of a uniquely identified agricultural property, and to collect data relating to the uniquely identified agricultural property. Method 400 then ends.

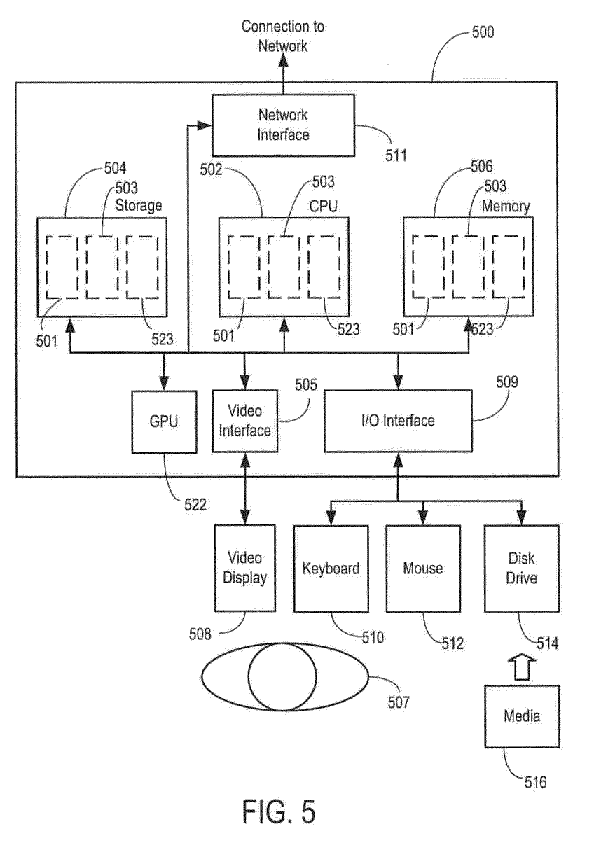

The present invention may be practiced in various embodiments. A suitably configured computer device, and associated communications networks, devices, software and firmware may provide a platform for enabling one or more embodiments as described above. By way of example, FIG. 5 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 507 may interact with the computer device 500 using a video display 508 connected by a video interface 505, and various input/output devices such as a keyboard 510, mouse 512, and disk drive or solid state drive 514 connected by an I/O interface 509. In known manner, the mouse 512 may be configured to control movement of a cursor in the video display 508, and to operate various graphical user interface (GUI) controls appearing in the video display 508 with a mouse button. The disk drive or solid state drive 514 may be configured to accept computer readable media 516. The computer device 500 may form part of a network via a network interface 511, allowing the computer device 500 to communicate with other suitably configured data processing systems (not shown).

The present invention may be practiced on any manner of computer device including a desktop computer, laptop computer, tablet computer or wireless handheld device. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

Thus, in one aspect, there is provided a computer-implemented geographic information system (GIS) for collecting data and identifying, registering and tracking agricultural and food-related properties by type and use, comprising: an agricultural premises registry database operatively connectable to a land registry or real estate database and one or more agricultural group databases, wherein, the agricultural premises registry database is adapted to: receive from the real estate database geographic location and boundary data for each property in a given jurisdiction; receive agricultural type and use information from the one or more agricultural group databases; and merge the geographic location and boundary data for each property from the real estate database with type and use information from the one or more agricultural group databases to uniquely identify one or more agricultural and food-related properties in the given jurisdiction.

In an embodiment, the agricultural and food-related properties are identified by cross-referencing the real estate database with information from one or more agricultural group databases maintained by one or more agricultural producer groups or organizations using at least one common data field.

In another embodiment, the computer-implemented GIS further comprises a plurality of mobile data collection devices for collecting data about an agricultural property on site, wherein the plurality of mobile data collection devices are adapted to obtain global positioning system (GPS) location coordinates to validate the location of a uniquely identified agricultural property, and to collect data relating to the uniquely identified agricultural property.

In another embodiment, the computer-implemented GIS further comprising an electronic display, and the system is adapted to identify all agricultural and food-related properties of a certain type or use within a given jurisdiction by highlighting the properties on a map generated on the electronic display.

In another embodiment, the computer-implemented GIS is further adapted to co-display agricultural and food-related properties of different types and uses on a map of a given jurisdiction generated on the electronic display based on one or more of proximity to another agricultural or food-related property, location within a geographic region, and shared property boundaries as identified in the real estate database.

In another embodiment, the ownership and contact information for each identified agricultural or food-related property can be accessed by selecting the agricultural or food-related property via a graphical user interface (GUI) in order to locate the ownership and contact information for each of the identified real estate properties.

In another embodiment, the computer-implemented GIS is further adapted to provide the ownership and contact information and an accurate geographic location for every identified agricultural or food-related property in a given jurisdiction.

In another embodiment, the computer-implemented GIS is further adapted to provide the ownership and contact information and an accurate geographic location for every identified agricultural or food-related property via wireless communications to one or more mobile devices.

In another embodiment, the computer-implemented GIS is further adapted to uniquely identify each agricultural or food-related property by a unique global location, number (GLN) for the purposes of tracking the movement of agricultural produce or livestock from an originating property to a destination property, and all via point properties in between.

In another aspect, there is provided a computer-implemented method for collecting data and identifying, registering and tracking agricultural and food-related properties by type and use in a geographic information system (GIS), comprising: providing an agricultural premises registry database operatively connectable to a land registry or real estate database and one or more agricultural group databases; receiving from the real estate database geographic location and boundary data for each property in a given jurisdiction; receiving agricultural type and use information from the one or more agricultural group databases; and merging the geographic location and boundary data for each property from the real estate database with type and use information from the one or more agricultural group databases to uniquely identify one or more agricultural and food-related properties in the given jurisdiction.

In an embodiment, the method further comprises identifying agricultural and food-related properties by cross-referencing the real estate database with information from one or more agricultural group databases maintained by one or more agricultural producer groups or organizations using at least one common data field.

In another embodiment, the method further comprises collecting data about an agricultural property on site utilizing a plurality of mobile data collection devices adapted to obtain global positioning system (GPS) location coordinates to validate the location of a uniquely identified agricultural property, and to collect data relating to the uniquely identified agricultural property.

In another embodiment, the method further comprises identifying all agricultural and food-related properties of a certain type or use within a given jurisdiction by highlighting the properties on a map generated on an electronic display.

In another embodiment, the method further comprises co-displaying agricultural and food-related properties of different types and uses on a map of a given jurisdiction generated on the electronic display based on one or more of proximity to another agricultural or food-related property, location within a geographic region, and shared property boundaries as identified in the real estate database.

In another embodiment, the method further comprises providing access to ownership and contact information for each identified agricultural or food-related property can by allowing selection of the agricultural or food-related property via a graphical user interface (GUI) in order to locate the ownership and contact information for each of the identified real estate properties.

In another embodiment, the method further comprises providing the ownership and contact information and an accurate geographic location for every identified agricultural or food-related property in a given jurisdiction.

In another embodiment, the method further comprises providing the ownership and contact information and an accurate geographic location for every identified agricultural or food-related property via wireless communications to one or more mobile devices.

In another embodiment, the method further comprises uniquely identifying each agricultural or food-related property by a unique global identification number for the purposes of tracking the movement of agricultural produce or livestock from an originating property to a destination property, and all via point properties in between.

In another aspect, there is provided a non-volatile computer readable medium storing, computer code that when executed on a computing device adapts the device to perform the above methods.

While the above description provides examples of one or more embodiments of the invention, it will be appreciated that numerous other embodiments may be within the scope of the present invention, as defined by the following claims.

1. A computer-implemented geographic information system (GIS) for collecting data and identifying, registering and tracking agricultural and food-related properties by type and use, comprising:
an agricultural premises registry database operatively connectable to a real estate database and one or more agricultural group databases, wherein, the agricultural premises registry database is adapted to:
receive from the real estate database geographic location and boundary data for each property in a given jurisdiction;
receive agricultural type and use information from the one or more agricultural group databases; and
merge the geographic location and boundary data for each property from the real estate database with type and use information from the one or more agricultural group databases to uniquely identify one or more agricultural and food-related properties in the given jurisdiction.

2. The computer-implemented GIS of claim 1, wherein the agricultural and food-related properties are identified by cross-referencing the real estate database with information from one or more agricultural group databases maintained by one or more agricultural producer groups or organizations using at least one common data field.

3. The computer-implemented GIS of claim 1, further comprising a plurality of mobile data collection devices for collecting data about an agricultural property on site, wherein the plurality of mobile data collection devices are adapted to obtain global positioning system (GPS) location coordinates to validate the location of a uniquely identified agricultural property, and to collect data relating to the uniquely identified agricultural property.

4. The computer-implemented GIS of claim 1, wherein the system further comprises an electronic display, and the system is adapted to identify all agricultural and food-related properties of a certain type or use within a given jurisdiction by highlighting the properties on a map generated on the electronic display.

5. The computer-implemented GIS of claim 4, wherein the system is further adapted to co-display agricultural and food-related properties of different types and uses on a map of a given jurisdiction generated on the electronic display based on one or more of proximity to another agricultural or food-related property, location within a geographic region, and shared property boundaries as identified in the real estate database.

6. The computer-implemented GIS of claim 1, wherein the ownership and contact information for each identified agricultural or food-related property can be accessed by selecting the agricultural or food-related property via a graphical user interface (GUI) in order to locate the ownership and contact information for each of the identified real estate properties.

7. The computer-implemented GIS of claim 1, wherein the system is further adapted to provide the ownership and contact information and an accurate geographic location for every identified agricultural or food-related property in a given jurisdiction.

8. The computer-implemented GIS of claim 1, wherein the system is further adapted to provide the ownership and contact information and an accurate geographic location for every identified agricultural or food-related property via wireless communications to one or more mobile devices.

9. The computer-implemented GIS of claim 1, wherein the system is further adapted to uniquely identify each, agricultural or food-related property by a unique global location number (GLN) for the purposes of tracking the movement of agricultural produce or livestock from an originating property to a destination property, and all via point properties in between.

10. A computer-implemented method for collecting data and identifying, registering and tracking agricultural and food-related properties by type and use in a geographic information system (GIS), comprising:
providing an agricultural premises registry database operatively connectable to a real estate database and one or more agricultural group databases;
receiving from the real estate database geographic location and boundary data for each property in a given jurisdiction;
receiving agricultural type and use information from the one or more agricultural group databases; and
merging the geographic location and boundary data for each property from the real estate database with type and use information from the one or more agricultural group databases to uniquely identify one or more agricultural and food-related properties in the given jurisdiction.

11. The computer-implemented method of claim 10, further comprising identifying agricultural and food-related properties by cross-referencing the real estate database with information from one or more agricultural group databases maintained by one or more agricultural producer groups or organizations using at least one common data field.

12. The computer-implemented method of claim 10, further comprising collecting data about an agricultural property on site utilizing a plurality of mobile data collection devices adapted to obtain global positioning system (GPS) location coordinates to validate the location of a uniquely identified agricultural property, and to collect data relating to the uniquely identified agricultural property.

13. The computer-implemented method of claim 10, further comprising identifying all agricultural and food-related properties of a certain type or use within a given jurisdiction by highlighting the properties on a map generated on an electronic display.

14. The computer-implemented method of claim 13, further comprising co-displaying agricultural and food-related properties of different types and uses on a map of a given jurisdiction generated on the electronic display based on one or more of proximity to another agricultural or food-related property, location within a geographic region, and shared property boundaries as identified in the real estate database.

15. The computer-implemented method of claim 10, further comprising providing access to ownership and contact information for each identified agricultural or food-related property can by allowing selection of the agricultural or food-related property via a graphical user interface (GUI) in order to locate the ownership and contact information for each of the identified real estate properties.

16. The computer-implemented method of claim 10, further comprising providing the ownership and contact information and an accurate geographic location for every identified agricultural or food-related property in a given jurisdiction.

17. The computer-implemented method of claim 10, further comprising providing the ownership and contact information and an accurate geographic location for every identified agricultural or food-related property via wireless communications to one or more mobile devices.

18. The computer-implemented method of claim 10, further comprising uniquely identifying each agricultural or food-related property by a unique global identification number for the purposes of tracking the movement of agricultural produce or livestock from an originating property to a destination property, and all via point properties in between.

19. A non-volatile computer readable medium storing computer code that when executed on a computing device adapts the device to perform the method of claim 10.
